(19) United States
(12) Patent Application Publication
(10) Pub. No.: US 2021/0402225 A1
(43) Pub. Date: Dec. 30, 2021

(54) PROTECTIVE HEAD COVERING

(71) Applicant: Marina Hossain, Surrey (CA)

(72) Inventor: Marina Hossain, Surrey (CA)

(21) Appl. No.: 16/910,287

(22) Filed: Jun. 24, 2020

(51) Int. Cl. A62B 18/04; A42B 3/20; A62B 7/02; A62B 9/00; A62B 23/02

(52) U.S. Cl. CPC A62B 18/04; A42B 3/20; A62B 23/02; A62B 9/003; A62B 7/02

(57) ABSTRACT

A protective mask is provided. A protective head covering for reducing exposure to contamination and infection for a user, comprising a fabric affixed to a perimeter of a frame such that the frame and the fabric enclose the user's face. A face shield housed in the frame. An adjustment apparatus affixed to the frame such that the frame may be reshaped. One or more exterior pores affixed to an exterior of the frame and a filtering mechanism housed within the one or more exterior pores.

### FIELD OF THE INVENTION

The present disclosure relates to a protective head covering more specifically, but not by way of limitation, more particularly to a reusable protective head covering which protects a user from any contamination and infection from entering their mouth, nose or eyes.

### BACKGROUND

During the outbreak of the Coronavirus disease 2019 (COVID-19), essential workers within the healthcare industry and patients in need of medical assistance have faced tremendous risk of transmission. These risks have highlighted the need for comprehensive personal protective equipment which protect all individuals from transmission. There are three sources of entry for viruses such as COVID-19: the mouth, the eyes, and the nose and there are two sources of exit of the virus, which are the mouth and the nose. At the hospital, the medical staff and all other workers are currently wearing multiple forms of protective equipment to address the sources of entry and spread to protect themselves from being infected such as face masks, goggles, and face shields. Below are the current market conditions for existing personal protective equipment employed which provide singular purpose protection.

Oxygen masks commonly employed at hospitals for patients have many disadvantages. Skin inflammation around the nose and mouth may result after prolonged use making further oxygen intake extremely painful and difficult, and under some circumstances, may lead to nasal erosion and opening of the skin for more infection. Contamination of oxygen tubes can also cause the spread of infectious disease. Allergic reactions from certain plastics inserted into the user's nose is another present hazard. In some circumstances, too much oxygen may be allowed to go into the user's lungs which can cause oxygen saturation may become fatal for some patients. Furthermore, patient's eyes are not protected from infection from airborne respiratory droplets.

Goggles are commonly implemented to protect the eyes from viral infection, but they have various disadvantages. User's may find it inconvenient to wear google in addition to other medical or protective devices and often can't be worn with prescription glasses.

Face masks are also employed to protect a user from breathing in contaminated air, but they suffer from many drawbacks. There exists an inability to protect a user's eyes, they are often inconvenient to wear, and they reduce the user's ability breath as they are often too close to the user's mouth. Additionally, they are often disposable and not made from biodegradable or compostable materials which creates more waste. Users can smudge their makeup and cause discoloring and contamination and often require frequent adjustments. Furthermore, they are not 100% effective in blocking the virus particles.

There is a need for a protective head covering that prevents from any contamination and infection entering the mouth, nose or eyes of the user that is reusable, is easily applied and adjusted onto a user, may be effortlessly sanitized, repaired and maintained, allows for attachment with an oxygen tank or a steamer for oxygen intake, hydration of the user's face or the application of medical compounds and essential oils.

### BRIEF SUMMARY

It is the object of the present invention to provide a protective head covering. A protective head covering for reducing exposure to contamination and infection for a user, comprising a fabric affixed to a perimeter of a frame such that the frame and the fabric enclose the user's face. A face shield housed in the frame. An adjustment apparatus affixed to the frame such that the frame may be reshaped. One or more exterior pores affixed to an exterior of the frame and a filtering mechanism housed within the one or more exterior pores.

In accordance with an aspect of the invention, there is provided a protective head covering for reducing exposure to contamination and infection for a user, comprising a fabric affixed to a perimeter of a frame such that the frame and the fabric enclose the user's face. A face shield housed in the frame. An adjustment apparatus affixed to the frame such that the frame may be reshaped. An inlet valve housed in the frame. One or more interior porous nozzles affixed to an interior of the frame. The inlet valve coupled to the one or more interior porous nozzles. One or more exterior pores affixed to an exterior of the frame and a filtering mechanism housed within the one or more exterior pores.

In accordance with an embodiment of the invention, a steamer may be attached to said inlet valve.

In accordance with an embodiment of the invention, the steamer is tabletop.

In accordance with an embodiment of the invention, the steamer is portable.

In accordance with an embodiment of the invention, an oxygen tank may be attached to the inlet valve.

In accordance with an embodiment of the invention, frame secures to the user such that an airtight seal if formed.

In accordance with an embodiment of the invention, the adjustment apparatus is a buckle.

In accordance with an embodiment of the invention, the adjustment apparatus is a clip.

In accordance with an embodiment of the invention, the fabric is removable.

In accordance with an embodiment of the invention, the face shield is removable.

In accordance with an embodiment of the invention, the filtering mechanism is an air filter.

In accordance with an embodiment of the invention, the air filter is replaceable or reusable.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a perspective view 100 in accordance with one embodiment.

FIG. 2 illustrates a perspective view 200 in accordance with one embodiment.

FIG. 3 illustrates a perspective view 300 in accordance with one embodiment.

FIG. 4 illustrates an applied view 400 in accordance with one embodiment.

FIG. 5 illustrates a rear view 500 in accordance with one embodiment.

FIG. 6 illustrates a front view 600 in accordance with one embodiment.

FIG. 7 illustrates a side view 700 in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

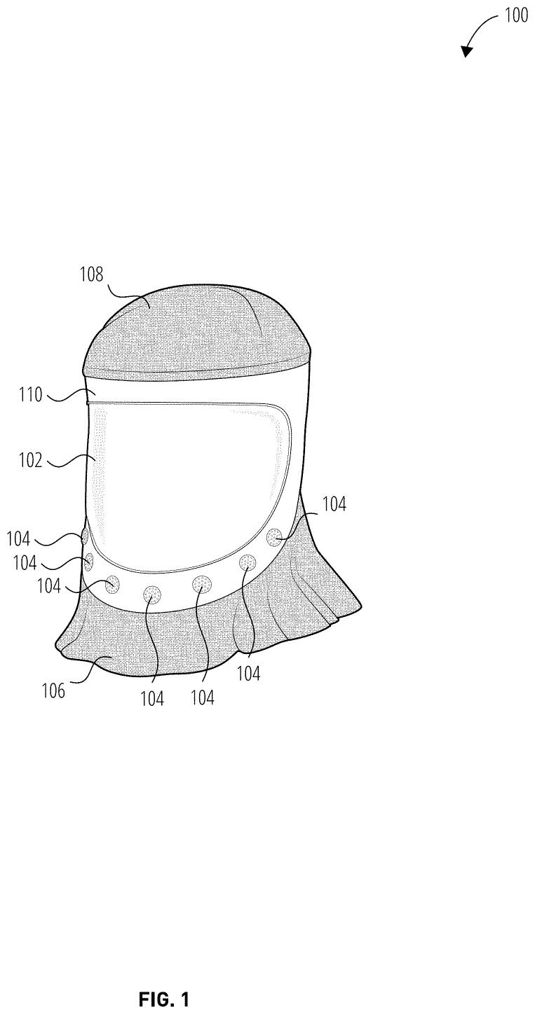

FIG. 1 depicts a perspective view 100 of a protective head covering as in one embodiment. The protective head covering reduces exposure to contamination and infection for a user and comprises a fabric affixed to a perimeter of a frame 110 such that the frame 110 and fabric enclose the user's face. In the embodiment presented, the fabric is shown employed as a cap 108 and as a surrounding cloth 106 to the areas of the user's head which have not been covered by the frame 110. The fabric functions to trap and prevent airborne contagions from reaching the user's head. The fabric may be removable, contributing to effortless disassembly for sanitization and repair.

A face shield 102 is housed in the frame 110 with one or more exterior pores affixed to an exterior of the frame 110. The exterior pores house a filtering mechanism which functions to prevent any airborne contagion from entering or exiting the user's mouth, nose or eyes while allowing the user to intake oxygen and purge carbon dioxide to the surrounding environment. The embodiment shown displays a plurality of air filters 104 within a plurality of exterior pores, which support transmission prevention. In some embodiments, the air filter 104 is reusable. In some embodiments, the air filter 104 is replaceable. The frame 110 is composed of a lightweight material, such as but not limited to, a thin plastic which provides the user effective portability while reducing strain on the user during prolonged use.

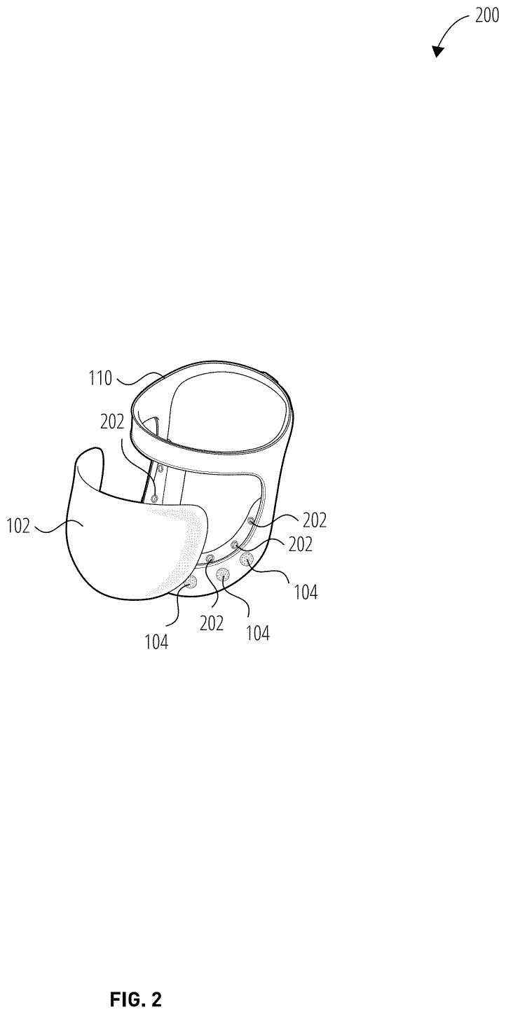

FIG. 2 depicts a perspective view 200 of a protective head covering as in one embodiment. In the embodiment shown, the face shield 102 is removable from the frame 110. A plurality of porous nozzles 202 are shown on the interior of the frame 110 which may be utilized in

In some embodiments, the face shield 102 is held in place by a clip which makes disassembly for sanitization, repair and maintenance effortless. The face shield 102 is composed of a transparent material, such as but not limited to, a thin plastic or similar lightweight materials which contribute to allow the user effective portability and reduce strain on the user for prolonged use. porous nozzle 202

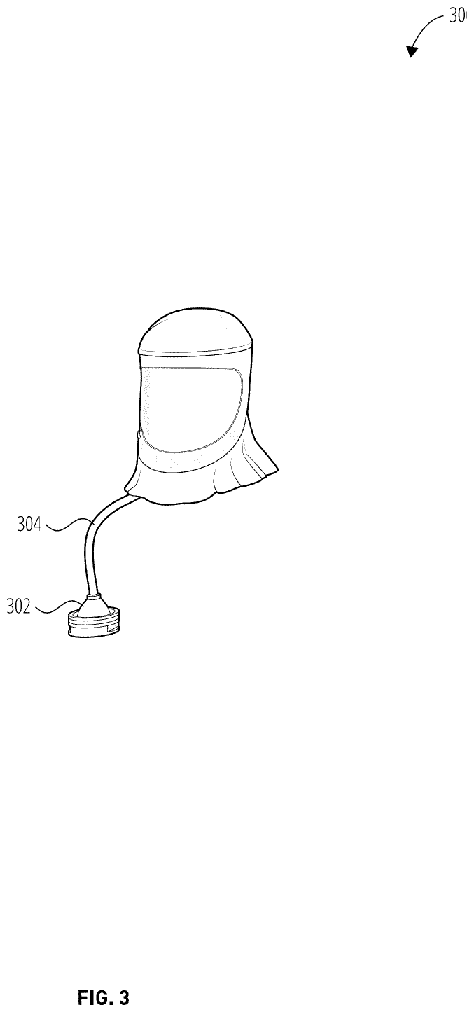

FIG. 3 depicts a perspective view 300 of a protective head covering as in one embodiment. In this embodiment, the frame 110 houses an inlet valve in addition to an adjustment apparatus affixed to the frame 110, one or more interior porous nozzles 202 affixed to an interior of the frame 110, and one or more exterior pores being affixed to an exterior of the frame 110. The inlet valve may be coupled to one or more interior porous nozzles 202.

A steamer 302 is shown with a connection tube 304 joined to the protective head covering via an inlet valve not presently shown. The steamer 302 may employed to produce steam from water to moisturize severely dried skin which may otherwise result in the opening of the skin and become susceptible to infection. In some embodiments, the steamer 302 is portable. In another embodiment, the steamer 302 is tabletop. In another embodiment, an oxygen tank may be attached to the inlet valve. This may be utilized by patients in healthcare facilities that require respiratory assistance while providing adequate protection from airborne contagions.

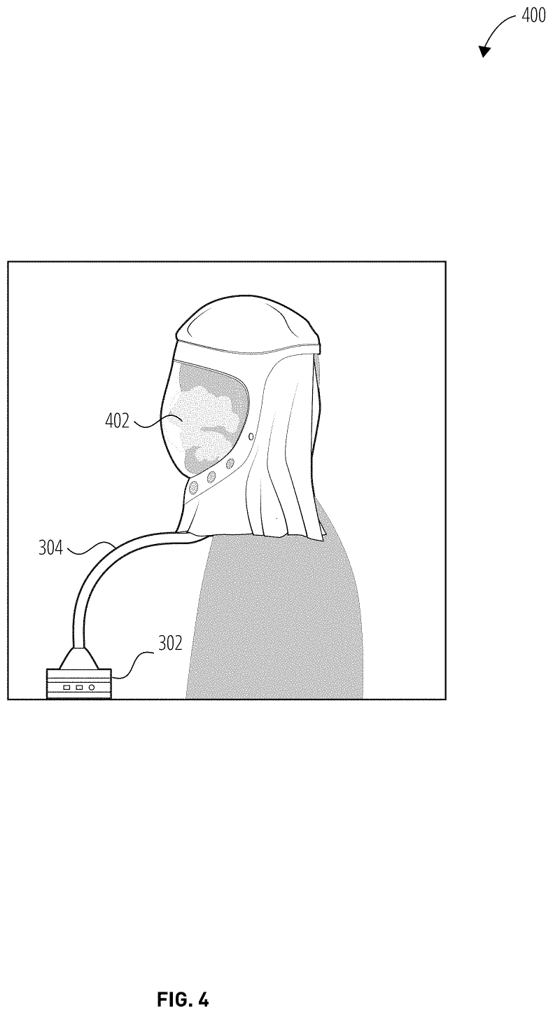

FIG. 4 depicts an applied view 400 of a protective head covering as in one embodiment. This embodiment displays steam 402 being dispensed onto a user's face. The steam 402 is produced in the steamer 302 and then transported via the connection tube 304 to one or more porous nozzles 202 where it is dispensed onto the user. The steamer 302 may be employed with essential oils or other medicinal compounds added into the water for easing symptoms of cough, cold, flu or respiratory illness by soothing the throat, fighting bacteria, release congestion, clear lungs and reducing inflammation.

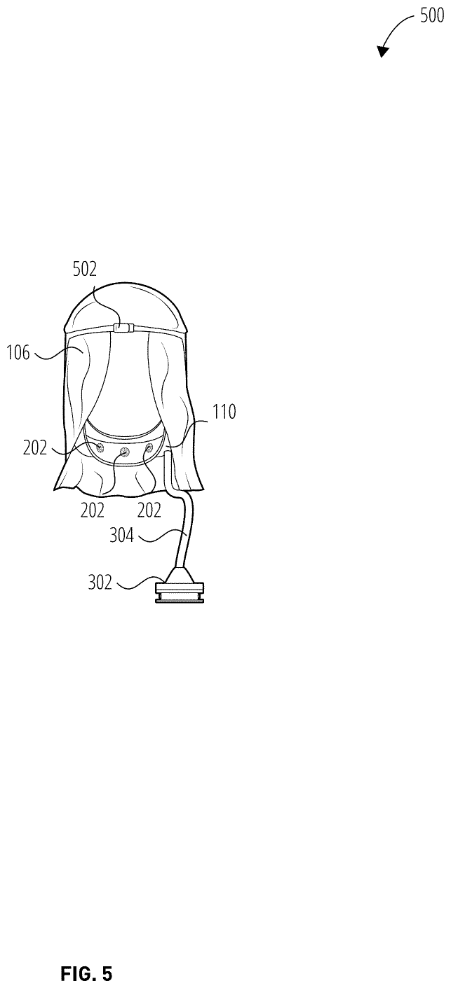

FIG. 5 depicts a rear view 500 of a protective head covering as in one embodiment. An adjustment apparatus is affixed to the frame 110 such that the frame 110 may be reshaped. This embodiment displays the adjustment apparatus as an adjustment buckle 502. In another embodiment, the adjustment apparatus is a clip. The adjustment buckle 502 allows for the protective head covering to be properly sized for the user such that it may be worn comfortably and is readily removable. In some embodiments, the adjustment buckle 502 can be modified such that the protective head covering is approximately two inches away from the user's face allowing for additional tools or equipment to be worn by the user such as prescription glasses. In some embodiments, the frame 110 secures to the user such that an airtight seal if formed.

Furthermore, this embodiment displays the connection tube 304 from a steamer 302 attached into the frame 110 with several porous nozzles 202 oriented towards the user. A break in complete enclosure of the user's head is shown by the configuration of the surrounding cloth 106 and frame 110. In other embodiments, the fabric is affixed to a perimeter of a frame 110 such that the frame 110 and fabric enclose the user's head. The adjustment apparatus is employed in disassembly

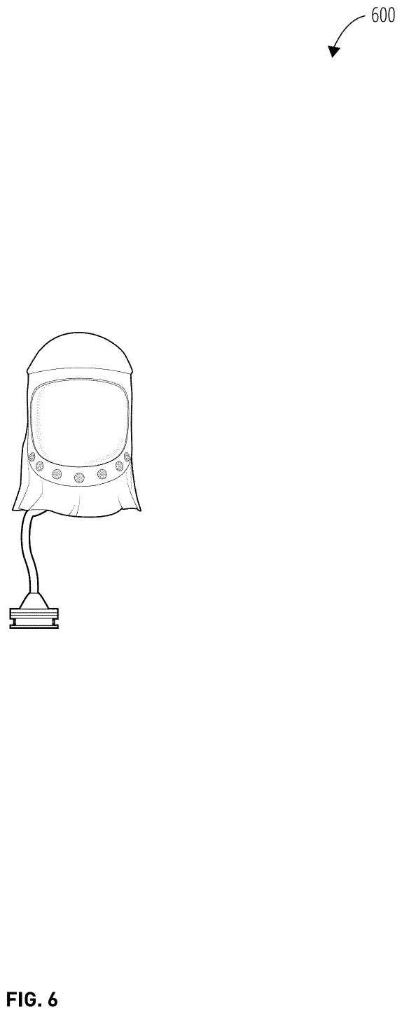

FIG. 6 depicts a front view 600 of a protective head covering as in one embodiment.

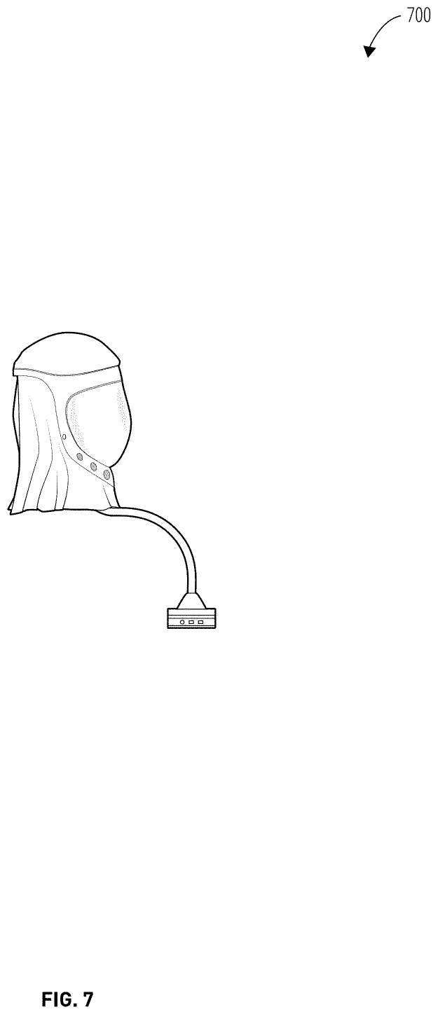

FIG. 7 depicts a side view 700 of a protective head covering as in one embodiment.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

What is claimed is:

1. A protective head covering for reducing exposure to contamination and infection for a user, comprising:
a fabric affixed to a perimeter of a frame such that said frame and said fabric enclose said user's face;
a face shield housed in said frame;
an adjustment apparatus affixed to said frame such that said frame may be reshaped;
one or more exterior pores affixed to an exterior of said frame; and
a filtering mechanism housed within said one or more exterior pores.

2. The protective head covering of claim 1, wherein said frame secures to said user such that an airtight seal is formed.

3. The protective head covering of claim 1, wherein said adjustment apparatus is a buckle.

4. The protective head covering of claim 1, wherein said adjustment apparatus is a clip.

5. The protective head covering of claim 1, wherein said fabric is removable.

6. The protective head covering of claim 1, wherein said face shield is removable.

7. The protective head covering of claim 1, wherein said filtering mechanism is an air filter.

8. The protective head covering of claim 7, wherein said air filter is replaceable or reusable.

9. A protective head covering for reducing exposure to contamination and infection for a user, comprising:
a fabric affixed to a perimeter of a frame such that said frame and said fabric enclose said user's face;
a face shield housed in said frame;
an adjustment apparatus affixed to said frame such that said frame may be reshaped;
an inlet valve housed in said frame;
one or more interior porous nozzles affixed to an interior of said frame;
said inlet valve coupled to said one or more interior porous nozzles;
one or more exterior pores affixed to an exterior of said frame; and
a filtering mechanism housed within said one or more exterior pores.

10. The protective head covering of claim 9, wherein a steamer may be attached to said inlet valve.

11. The protective head covering of claim 10, wherein said steamer is tabletop.

12. The protective head covering of claim 10, wherein said steamer is portable.

13. The protective head covering of claim 9, wherein an oxygen tank may be attached to said inlet valve.

14. The protective head covering of claim 9, wherein said frame secures to said user such that an airtight seal if formed.

15. The protective head covering of claim 9, wherein said adjustment apparatus is a buckle.

16. The protective head covering of claim 9, wherein said adjustment apparatus is a clip.

17. The protective head covering of claim 9, wherein said fabric is removable.

18. The protective head covering of claim 9, wherein said face shield is removable.

19. The protective head covering of claim 9, wherein said filtering mechanism is an air filter.

20. The protective head covering of claim 19, wherein said air filter is replaceable or reusable.
